(19) United States
(12) Patent Application Publication
(10) Pub. No.: US 2025/0180891 A1
(43) Pub. Date: Jun. 5, 2025

(54) RISLEY PRISM OPTICAL POINTING CONTROLLER

(71) Applicant: BAE SYSTEMS Information and Electronic Systems Integration Inc., Nashua, NH (US)

(72) Inventors: David B. Jordan, Hollis, NH (US); James L. Kingston, Temple, NH (US); Clifford D. Caseley, Hudson, NH (US)

(73) Assignee: BAE SYSTEMS Information and Electronic Systems Integration Inc., Nashua, NH (US)

(21) Appl. No.: 18/526,154

(22) Filed: Dec. 1, 2023

(51) Int. Cl. G02B 26/08; G02B 27/00

(52) U.S. Cl. CPC G02B 26/0891; G02B 27/0012

(57) ABSTRACT

A controller applies iterative ray tracing and root finding to determine an orientation difference Δθ_{d} of Risley Prism Assembly (RPA) prism elements required to provide a desired light refraction angle γ_{d}. In each iteration, a linear approximation is applied between lower and upper angle difference limits to determine an approximate value Δθₐ, and ray tracing is applied to determine a corresponding refraction angle γₐ. Depending on whether γₐ is greater than or less than γ_{d}, the upper or lower angle difference limit is reset to Δθₐ, and the process continues until convergence. Ray tracing also determines an angular rotation ϕₐ of a refracted beam about the rotation axis at Δθ_{d}, and the orientations of the prism elements are adjusted to provide a desired pointing direction γ_{d}, ϕ_{d} according to Δθ_{d}, ϕ_{d}, and ϕₐ. Prism element imperfections are accommodated in the ray tracing.

### RELATED APPLICATIONS

This application is related to U.S. patent application Ser. No. 18/526,203, also by the present Applicant, filed concurrently with this application, which is herein incorporated by reference in its entirety for all purposes.

### FIELD

The disclosure relates to optical pointing devices, and more particularly to optical pointing devices that implement Risley prisms.

### BACKGROUND

Many optical systems require a “pointer” to direct light from a selected location or region within a field of interest (FOI) to a “target” that is within the optical system, or vice-versa, where the terms “pointer” and “pointing system” are used herein interchangeably.

A pointing system that implements Risley prisms, referred to herein as a Risley Prism Assembly (“RPA”) can be preferable to a Gimbal pointing system, for example in applications where space is at a premium, and/or where a low profile with a wide field of view is required. However, it can be difficult to rapidly calculate the orientations of the RPA rotatable elements that are needed to establish a desired pointing direction, especially if a very high degree of pointing accuracy is requires, and especially if each of the rotatable elements includes a plurality of prisms, as is the case for achromatic RPAs.

One approach is to pre-calculate the required RPA rotatable element orientations for a large number of pointing angles, and then tabulate the results. However, some pointing applications, such as satellite laser communications, can require that the pointing direction have an accuracy of better than 10 micro radians. Likewise, high resolution imagery of a scene requires precise and stable pointing accuracy. A pre-calculated table would need to be prohibitively large to provide this degree of accuracy. Furthermore, RPAs are subject to assembly and manufacturing errors that can cause the rotatable elements deviate slightly from theoretically perfect alignment with their rotation axis. These “tilt angle” errors will vary between pointing devices, and can be sufficient to prevent accurate pointing based on pre-calculated and tabulated RPA rotatable element orientations that assume perfectly aligned RPA.

What is needed, therefore, is an apparatus and method for accurately pointing a Risley Prism Assembly (RPA) that does not require tabulated pre-calculation of RPA rotatable element orientations, and that can compensate for manufacturing and assembly tilt angle errors that vary between pointing systems.

### SUMMARY

The present disclosure is an apparatus and method for accurately pointing a Risley Prism Assembly (RPA) that does not require tabulated pre-calculation of RPA rotatable element orientations, and that can compensate for manufacturing and assembly tilt angle errors that vary between pointing systems.

A Risley prism assembly (RPA) is disclosed that includes a first prism element and a second prism element. The first and second prism elements have angular orientations that are variable by causing first and second RPA motors to rotate the first and second prism elements about a common central rotation axis. Light entering the RPA along the central rotation axis and passing through both of the first and second prism elements is refracted away from the central rotation axis at a maximum refraction angle γₘₐₓ when an angular orientation difference Δθ between the angular orientation θ₁ of the first prism elements and the angular orientation θ₂ of the second prism element is zero, and at a minimum refraction angle γₘᵢₙ when Δθ=180 degrees.

The RPA further includes a controller that is configured apply an iterative root finding method of false position (MFP) to approximate a value Δθ_{d} of the angular orientation difference Δθ at which the light will be refracted at a desired refraction angle γ_{d} formed between a desired pointing direction and the central rotation axis, and direct the first and second RPA motors to adjust the angular orientations of the first and second prism elements to cause the light to emerge from the RPA in the desired pointing direction when the light enters the RPA along the central rotation axis, or direct the first and second RPA motors to cause the light to emerge from the RPA along the central rotation axis when the light enters the RPA along the desired pointing direction.

In embodiments, applying the MFP comprises:
A) establishing converging angle variable Δθ_{c} and limiting angle variables Δθ_{L1}, Δθ_{L2}, γ_{L1}, and γ_{L2}, said limiting angle variables having initial values Δθ_{L1}=0 degrees, Δθ_{L2}=180 degrees, γ_{L1}=γₘₐₓ, and γ_{L2}=γₘᵢₙ;
B) setting Δθ_{c}=(Δθ_{L2}−Δθ_{L1})[(γ_{L1}−γ_{d})/(γ_{L1}−γ_{L2})];
C) applying ray tracing to determine a refraction angle γ_{c} between the beam of light and the central rotation axis, and an angular rotation ϕ_{c} of the beam of light about the central rotation axis, that would result if the beam of light entered the RPA along the central rotation axis while the angular orientation θ₁ of the first prism element was equal to 0 and the angular orientation θ₂ of the second prism element was equal to Δθ_{c};
D) if γ_{c} is greater than γ_{d}, setting Δθ_{L1}=Δθ_{c} and γ_{L1}=γ_{c}, or, if γ_{c} is less than γ_{d}, setting Δθ_{L2}=Δθ_{c} and γ_{L2}=γ_{c};
E) repeating steps B) through D) until |γ_{c}−γ_{d}| is less than a specified maximum; and
F) setting Δθ_{d}=Δθ_{c}.

The controller is further configured in embodiments to adjust the angular orientations of the first and second prism elements according to according to Δθ_{d}, ϕ_{c} and a desired angle of rotation ϕ_{d} of the desired pointing direction about the central rotation axis.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates refraction of a beam of light by a pair of rotatable prisms included in a Risley prism assembly (RPA), with the prisms oriented to provide maximum refraction of the light, according to the prior art;

FIG. 1B illustrates refraction of the beam of light by the pair of rotatable prisms of FIG. 1A, with the prisms oriented to provide minimum refraction of the light, according to the prior art;

FIG. 1C is a cross-sectional illustration of an achromatic RPA of the prior art in which each of the two prism elements includes an assembly of three prisms;

FIG. 2A is a block diagram of a Risley prism pointing system according to an embodiment of the present disclosure in which a beam of light from a laser is refracted by the RPA onto a field of interest;

FIG. 2B is a block diagram of a Risley prism pointing system according to an embodiment of the present disclosure in which light from a field of interest is refracted by the RPA into a camera;

FIG. 2C is a block diagram of a Risley prism pointing system according to an embodiment of the present disclosure in which the RPA is included in a laser communication terminal;

FIG. 3 is a graph that illustrates the Method of False Position of the present disclosure;

FIG. 4 is a flow diagram that illustrates the Method of False Position of the present disclosure; and

FIG. 5 illustrates calibration of tilt angle imperfections of prism elements according to embodiments of the present disclosure.

### DETAILED DESCRIPTION

The present disclosure is an apparatus and method for accurately pointing a Risley Prism Assembly (RPA) that does not require tabulated pre-calculation of diffraction angles, and that can compensate for manufacturing and assembly tilt angle errors that vary between pointing systems. Applications include high resolution imaging and satellite communications that require precise pointing requirements.

It will be understood that examples presented herein with reference to specific types of optical pointers are intended to illustrate features that apply generically to optical systems that direct either beams of light or fields of light to and/or from a FOI, unless otherwise explicitly stated, or otherwise required by context.

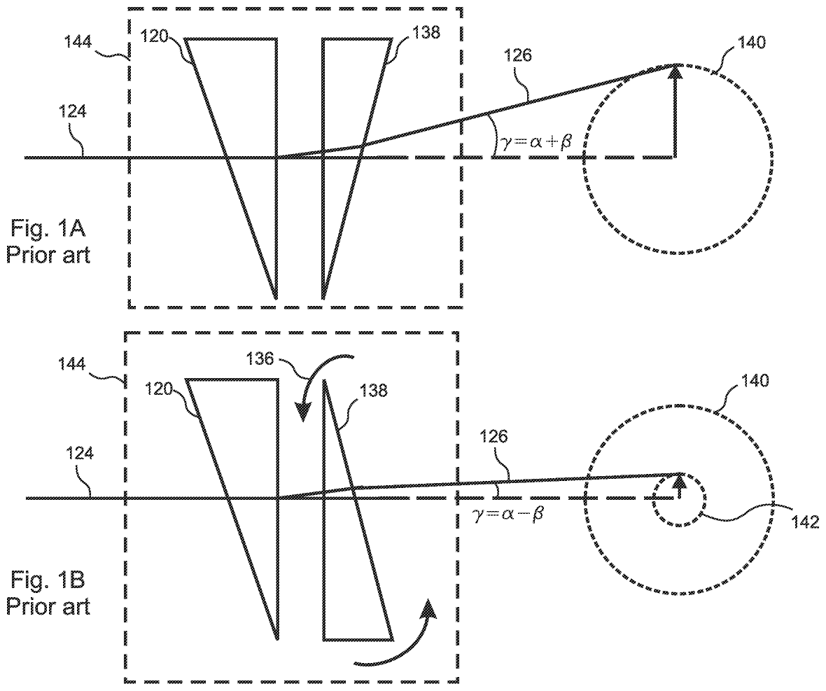

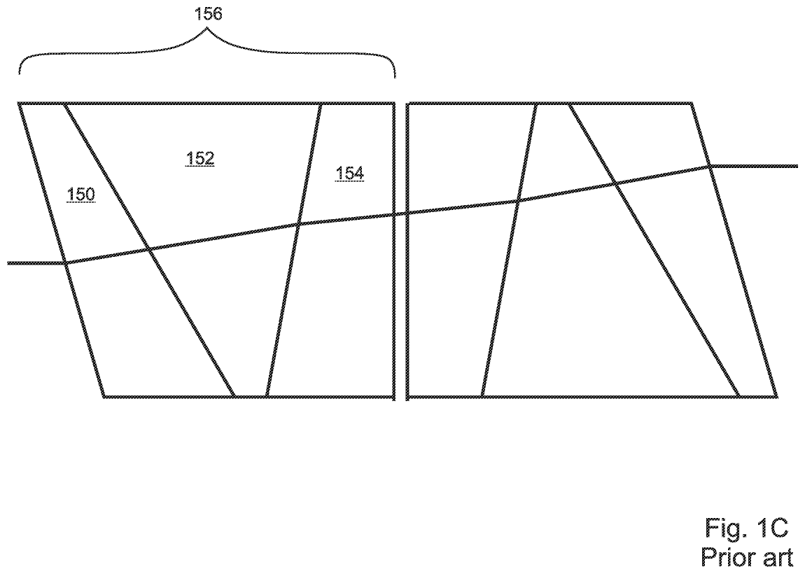

With reference to FIGS. 1A and 1B, a Risley pointer uses refraction to redirect light by passing it through a “Risley” prism assembly (RPA) 144, which combines at least two prism elements 120, 138 that are both independently rotatable 136 about a common axis 124. In FIG. 1B, the two prisms 120, 138 are aligned (zero degrees relative rotation Δθ) such that the refraction by the two prisms 120, 138 of a beam directed along the common axis 124 is cumulative, whereby the total refraction angle γ is the sum of their separate refraction angles, i.e. γ=α+ß. In FIG. 1B the second prism 138 has been rotated such that the refraction of the beam by the two prisms 120, 138 is subtractive (Δθ=180 degrees), whereby the total refraction angle γ is the difference between their separate refraction angles, i.e. γ=α−ß.

By rotating both of the prisms 120, 138, the impact point of the outgoing beam 126 on a target can be directed to any point within an annular region bounded by a maximum refraction circle 140 corresponding to γ=α+ß and a minimum refraction circle 142 corresponding to γ=α−ß. Typically, two prisms 120, 138 having the same dispersion angle α are implemented in an RPA 144, so that the minimum refraction circle 142 is reduced to a central point, allowing the output beam 126 to be directed to a target anywhere within the disk defined by the maximum refraction circle 140. It will be noted that the pointing circles 140, 142 in FIGS. 1A and 1B are presented as if the light were directed into the page, while other elements in the drawings are presented with the light traveling in the plane of the page.

However, a simple Risley prism assembly 144, as illustrated in FIGS. 1A and 1B, may not be suitable for some applications, because two-prism RPAs 144 are inherently “chromatic,” in that the prisms 120, 130 diffract different wavelengths of light at different angles. Instead, with reference to FIG. 1C, an achromatic RPA having prism “elements” 156 that each comprise more than one prism 150, 152, 154 can be implemented to achieve refraction angles that are substantially independent of wavelength. An example is the achromatic RPA disclosed in U.S. Pat. No. 9,140,901, also by the present Applicant, which is incorporated herein by reference in its entirety for all purposes.

In the example of FIG. 1C, the achromatic RPA implements a “pair of triplets” 156 of prisms 150, 152, 154, i.e. six prisms, where each of the “triplets” 156 is a prism element 156 comprising three prisms 150, 152, 154 that are made from different materials. Except where otherwise stated or required by context, references herein to the two “prism elements” 156 of an RPA refer generically to the two rotating elements of the RPA, each of which can include a plurality of prisms, such as the “triplets” 156 of FIG. 1E.

Given the direction of the incoming beam 124 and the known angular orientations of the two prism elements 156 of an RPA, as well as the optical dimensions and refractive indices of the prisms 150, 152, 154 included in the prism elements 156, the diffraction angle γ and the rotation ϕ of the outgoing beam 126 about the central rotation axis can be readily calculated by ray tracing. However, pointing applications usually require a calculation that is the opposite of ray-tracing, i.e. calculation of the rotation angles of the prism assemblies 156 that are required to achieve a desired direction of the outgoing beam 126. This calculation requires that the relative angular rotation Δθ between the two prism elements 156 be determined based on a given, desired diffraction angle γ. Once Δθ is known, ϕ can be readily calculated, and an overall rotation of both prism elements 156 can be determined to obtain the desired pointing direction.

When each prism element 156 of the RPA is a single prism 120, 138, as shown in FIGS. 1A and 1B, then a closed mathematical expression exists that can be used to exactly calculate Δθ. However, for more complex, multi-prism assemblies 156, such as are illustrated in FIG. 1C, a closed mathematical solution does not exist.

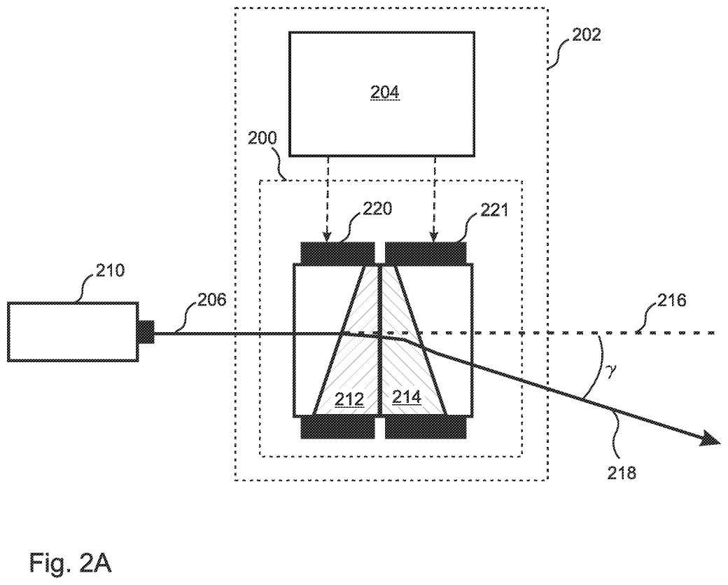

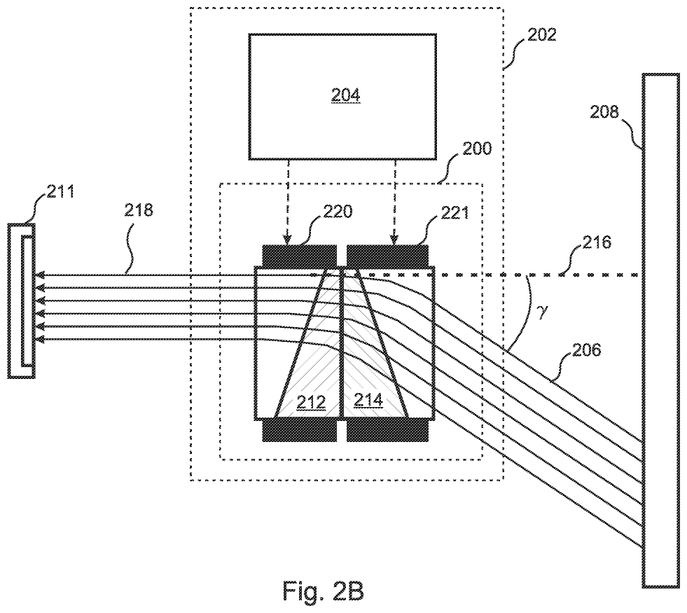

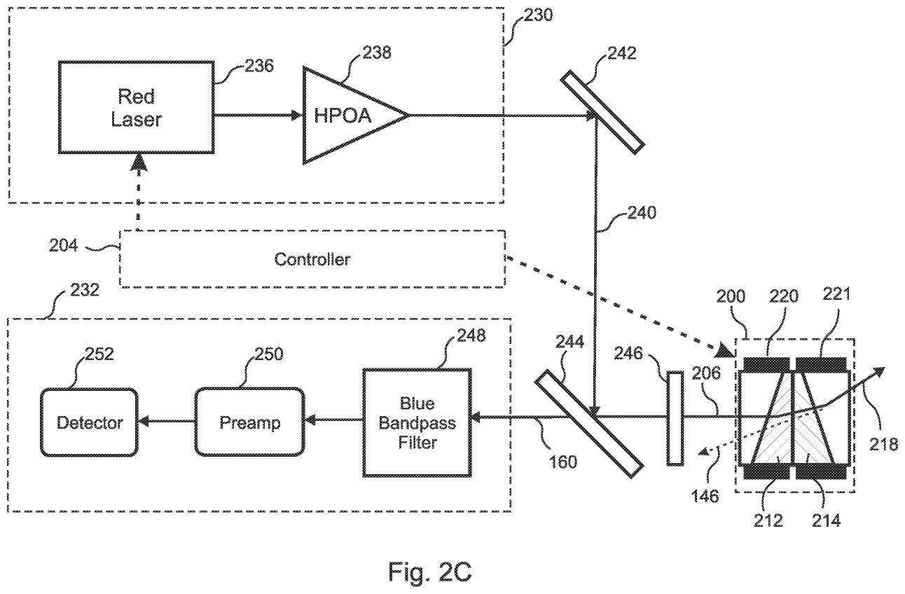

According to the present disclosure, with continuing reference to FIGS. 2A and 2B, a pointing system 202 includes a Risley prism assembly (RPA) 200 and a controller 204. The RPA comprises two prism elements 212, 214 that are rotated about a common axis 216 by a corresponding pair 220, 221 of RPA motors so that the prism elements 212. 214 are independently rotatable about the central axis 216. The controller is configured to calculate the rotations of the prism elements 212, 214 about the central rotation axis 216 that are required to cause incoming light 206 to be diffracted in a desired direction.

In the example of FIG. 2A, a single beam of light 206 from a laser 210 entering the RPA 200 along the central rotation axis 216 emerges from the RPA 200 having a specified refraction angle γ and rotation about the central rotation axis of ϕ (not shown). For simplicity, it is further assumed that the minimum value of γ is zero, and ϕ is defined to be zero when the second prism element 214 is rotated to be “aligned” with the first prism element 212, as shown in FIG. 2A, such that γ is at its maximum value. However, it will be clear to those of skill in the art that the present disclosure is not limited to this exemplary embodiment, and that the scope of the present disclosure extends to more general applications where, for example, the minimum value of γ is not zero, as illustrated in FIG. 1B.

In one example the controller 204 comprises at least one processor with memory and having communications capability to communicate at least with the motors that control the prism elements, and in embodiments with other apparatus from which it receives pointing instructions, such as a satellite tracking system or a weapons targeting system.

With reference to FIG. 2B, in other embodiments light 206 from a field of interest FOI 208 is directed by the RPA 200 to a camera 211. By rotating the prism elements 212, 214 of the RPA 200, the controller is able to select a region or “frame” within a field of interest (FOI) 208 to be directed to the camera 211. In one embodiment, the FOI 208 is an enemy encampment or airfield, and the camera 211 is a high resolution camera located in a satellite or on an unmanned aerial vehicle (UAV) or other aircraft.

With reference to FIG. 2C, in embodiments the Risley pointer 202 is implemented as part of a laser communication system. The illustrated example is a simplified block diagram of a “red” laser communication terminal that includes a transmitting section 230, a receiving section 232 and a controller 204. The message transmitting section 230 includes a “red” laser 236 and high-power optical amplifier (HOPA) 238 that generate a transmitted laser communication beam 240 that is linear polarized. The transmitted beam 240 is directed by a mirror 242 to a polarized beam splitter or dichroic filter 244 that functions as a transmit/receive diplexer (TX-RX diplexer), through a quarter wave plate 246 that converts the linear polarized beam into circular polarization, and then to the RPA 200, which directs the transmitted beam 218 to a remote node. “Blue” circular polarized light received from the remote node follows the same path in reverse through the RPA 200, being converted by the quarter wave plate 246 into linear polarized light that passes through the polarized beam splitter or dichroic filter 244 into the receiving section 232, which includes a blue bandpass filter 248, a preamplifier 250, and a light detector 252.

As a first step of calculating the rotations of the prism elements 212, 214 about the central rotation axis 216 that are required to cause incoming light 206 to be diffracted in a desired direction, the controller 204 is configured to determine a relative rotation angle Δθ between the prism elements 212, 214 that will cause the incoming light 206 to be refracted at a desired angle γ_{d}. In embodiments, the controller 204 assumes that the first prism element 212 remains fixed and only the second prism element 214 is hypothetically rotated by an angle Δθ to obtain the desired refraction angle γ.

If the optical characteristics of the prism elements 212, 214 are known, the refraction angle γ and rotation about the central rotation axis ϕ of the output vector 218 that result from specified angular orientations of the prism elements 212, 214 can be readily determined by “ray tracing,” i.e. by calculating the successive refractions of a light beam 206 as it passes through each prism of each of the prism elements 212, 214. Accordingly, γ is readily determined by ray-tracing if Δθ is known. However, when each of the prism elements 212, 214 includes a plurality of prisms, there is no closed solution that enables Δθ to be readily calculated if γ is known.

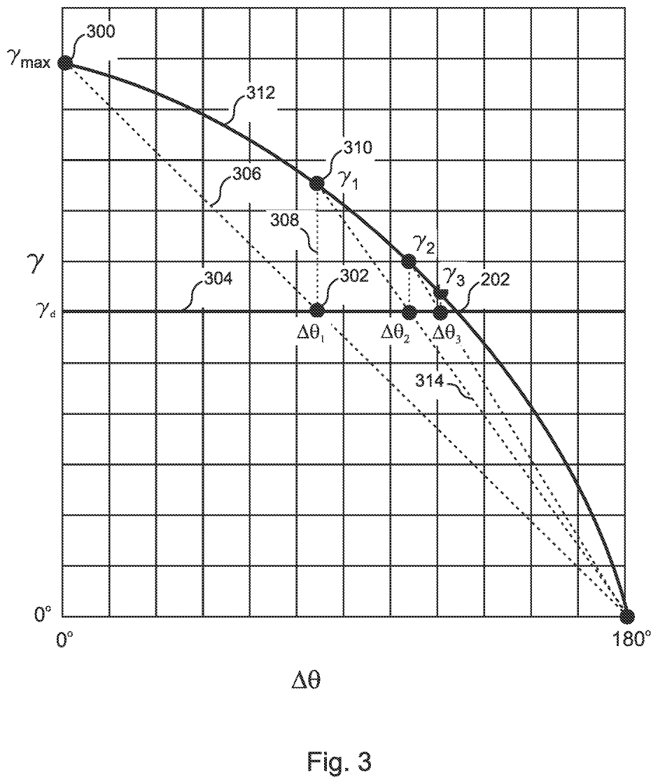

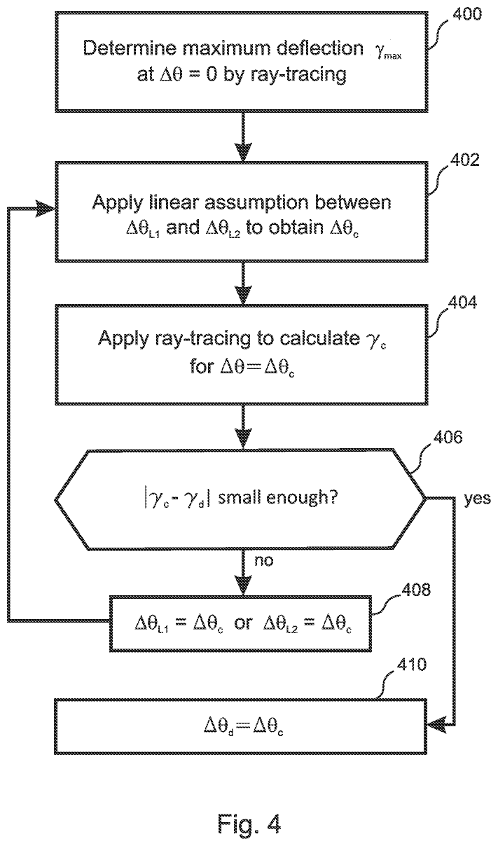

Instead, according to the present disclosure, the controller 204 approximates the required relative rotation Δθ to any desired degree of accuracy by implementing an iterative root finding method of false position, referred to herein as the Method of False Position (MFP). With reference to FIGS. 3 and 4, as a first step, ray tracing is applied to determine 400 the maximum refraction γₘₐₓ 300, which is obtained when the prism elements are “aligned” and Δθ=0. Because these values represent the starting point in an iterative process, Δθ=0 can be considered to be Δθⱼ₌₀, and γₘₐₓ can be considered to be γⱼ=0. As noted above, for clarity it is assumed in FIGS. 3 and 4 that the refraction γ is zero when Δθ=180 degrees, but the present disclosure is not limited to that assumption. In the more general case, a minimum refraction γₘᵢₙ at Δθ=180 degrees is not necessarily zero, and is also determined by ray-tracing.

A relative rotation Δθ₁ 302 (where it is assumed that only the second prism element 214 is rotated) is then calculated 404 for which the light would be refracted at the desired pointing angle γ_{d} 304 if γ were a linear function of Δθ. This “linear assumption” is indicated as a dashed line 306 in FIG. 3, with Δθ₁ 302 being the intersection of the “linear” dashed line 306 and the horizontal line 304 indicating the value γ_{d} 304. Ray tracing 308 is then applied 406 to Δθ₁ to determine the actual refraction angle γ₁ 310 that would result from a relative rotation of Δθ₁, where the curved line 312 in FIG. 3 indicates the actual, non-linear dependence of γ on Δθ.

If γ₁ is greater than γ_{d}, as shown in FIG. 3, the same linear approximation 314 is applied between Δθ_{L1}=Δθ₁ and Δθ=180 degrees to determine by how much Δθ₁ should be increased to obtain a new relative rotation Δθ₂ that is greater than Δθ₁. On the other hand, if γ₁ is less than γ_{d}, the linear approximation is applied between Δθ_{L2}=0 and Δθ=Δθ₁ to determine by how much Δθ₁ should be decreased to obtain a new relative rotation Δθ₂ that is less than Δθ₁. For simplicity of illustration, in FIGS. 3 and 4 it is assumed that γⱼ is always less than γ_{d}.

This process is repeated, each time incrementing 402 the index j, and each time resetting either the upper angle difference limit ΔθL₁ or the lower angle difference limit Δθ_{L2} of the linear approximation, according to the equation

$$Δ {θ}_{j} = ( Δ {θ}_{L 2} - {Δθ}_{L 1} ) [ ( {γ}_{L 1} - {γ}_{d} ) / ( {γ}_{L1} - {γ}_{L 2} ) ] \qquad ( 1 )$$

where γ_{L1} is the value of γ at Δθ_{L1}, and γ_{L2} is the value of γ at Δθ_{L2}, as determined by ray-tracing, until a difference 408 between the calculated refraction angle γⱼ and the desired refraction angle γ_{d} has been reduced to below a specified maximum, at which point Δθⱼ is considered 410 to be the “desired” result Δθ_{d}.

It will be noted that each application of ray-tracing during the MFP calculation also determines the angle ϕⱼ by which the output beam would be rotated about the central rotation axis 216 if the first prism element remained fixed and only the second prism element was rotated by an angle Δθⱼ. As a second step, the controller determines a difference Δϕ between ϕⱼ and a desired pointing rotation da about the central rotation axis 216. The angular orientations of the prism elements 212, 214 that are required to obtain the desired pointing direction are then Δϕ for the first prism element 212 and (Δϕ+ϕⱼ) for the second prism element 214.

The disclosed MFP method has the dual advantages of calculational simplicity and rapid convergence, even when the refraction angle is required to be accurate to within better than 10 micro-radians. The controller 204 is thereby able to quickly and accurately determine required rotation angles of the RPA prism elements 212, 214, even if the pointing direction is rapidly varied.

It should be noted that, by symmetry, there will always be two values of Δθ, i.e. two “refraction solutions,” that will produce a desired refraction γ_{d}, in that γ_{d} can be obtained for Δθ=±Δθ_{d} (except in the limiting cases where Δθ_{d}=0 or Δθ_{d}=180°). Accordingly, two pointing “solutions” will always be available that will result in the same refraction angle γ, while resulting in rotation angles ϕ about the central rotation axis 216 of opposite sign. Depending on the angular orientations of the two prism elements 212, 214 before they are rotated, one of the two pointing solutions will be “optimal,” in that it will require smaller net rotations of the two prism elements 212, 214.

In embodiments, the controller 204 is further configured to select the optimal solution, where the “optimal” solution is defined to be either the solution that minimizes the size of the largest rotation, or the solution that minimizes the sum of the two rotations. Minimizing the largest rotation can provide the shortest pointing time if the two prism elements 212, 214 can be rotated simultaneously. However, in some embodiments, such as satellites and unmanned aerial vehicles (UAVs), the total power that is available for energizing the RPA motors 220, 221 is limited. For example, a satellite might depend on power from solar cells to energize the RPA motors 220, 221, or a UAV may depend on power derived from a fuel cell to energize the RPA motors 220, 221. In both cases, the peak available power that can be applied to the RPA motors 220, 221 will be limited. In such cases, it may be necessary to limit the peak power that is drawn from the power source during rotation of the prism elements 212, 214, for example by rotating the two prism elements 212, 214 sequentially In such cases, it may be optimal to choose the pointing solution that minimizes the sum of the two rotations, which will minimize the time required for sequential rotation of the prism elements 212, 214, and will also minimize the total energy that must be supplied by the power source to the RPA motors 220, 221.

As noted above, RPAs are subject to assembly and manufacturing errors that can cause the rotating elements to be deviate slightly from theoretically perfect alignment with their rotation axis. These “tilt angle” errors will vary between nominally identical prism elements 212, 214, and can be sufficient to prevent accurate pointing based on tabulated values of γ and ϕ vs Δθ that are pre-calculated assuming a perfectly aligned RPA 202. Embodiments of the present disclosure easily compensate for tilt angle errors by calibrating the tilt angles of the prism elements 212, 214, and then incorporating the measured tilt angles into the ray-tracing calculations.

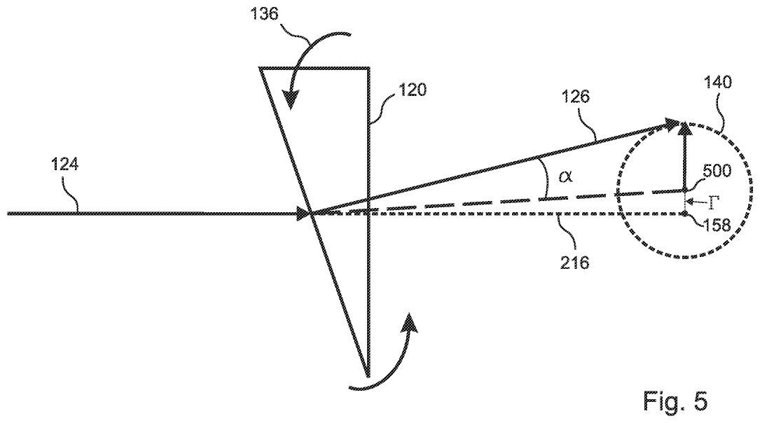

While the individual prisms that are included in each of the RPA prism elements 212, 214 may have separate tilt angle errors, i.e. each prism may have its own positional error within the prism element, these individual tilt angle errors will remain fixed relative to each other within the prism element. Accordingly, with reference to FIG. 5, for the purpose of calibrating and correcting for tilt angle errors, each prism element 212, 214 can be treated as if it were a single prism 120, 138, and it is only necessary to determine the net refraction angle α of each of the two prism elements 212, 214, and the displacement or “tilt” of the refracted light cone for each of the elements 212, 214.

As illustrated in FIG. 5, for each of the prism elements 212, 214, measuring the tilt angles during this calibration step includes determining a (the net diffraction angle of the element) and the offset Γ (as a function of distance from the element) of the center 500 of the pointing circle 140 away from intersection 158 of the central rotation axis 216 with the plane of the pointing circle 140. This can be accomplished during calibration by rotating 136 the element 120 within the RPA 200 and noting the impact location of the diffracted light upon a calibration target such as a high resolution focal plane array (FPA) (not shown). Because the tilt angle errors will be small, it can be assumed that the pointing “circle” 140 will be circular. It is therefore only necessary to measure the pointing direction for a few selected angular orientations of the element 120 to determine the pointing circle 140, and from that to determine α and Γ. A small adjustment to the angular orientation of the prism element that is defined as “0” may also be needed.

Once α and Γ have been determined for each of the prism elements 212, 214, they can be included in the ray-tracing calculations, with almost no increase in computational complexity or speed. It will be noted that the pointing circles 140 in FIGS. 1A-1B and 5 are presented as if the light were directed into the page, while other elements in the drawings are presented with the light traveling in the plane of the page.

In some embodiments, the RPA prism elements 212, 214 are mounted separately in the RPA 202 and calibrated, while in other embodiment the calibration is performed on the assembled RPA 202. In the latter case, each of the prism elements 212 or 214 is rotated while the other prism element 214 or 212 remains fixed, and α and Γ for the rotated prism element are calculated from the measured pointing directions by assuming that the other prism element is perfectly oriented. After this process has been completed for both of the prism elements 212, 214, it can be repeated using the previously determined values of α and Γ until the values converge.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A Risley prism assembly (RPA) comprising:
a first prism element and a second prism element, each of the first and second prism elements having an angular orientation about a common central rotation axis that is variable by causing respective first and second Risley prism assembly motors (RPA motors) to rotate the first and second prism elements about the central rotation axis, wherein light entering the RPA along the central rotation axis and passing through both of the first and second prism elements is refracted away from the central rotation axis at a maximum refraction angle γₘₐₓ when an angular orientation difference Δθ between the angular orientation θ₁ of the first prism element and the angular orientation θ₂ of the second prism element is zero, and at a minimum refraction angle γₘᵢₙ when Δθ=180 degrees; and
a controller configured to:
apply an iterative root finding method of false position (MFP) to approximate a value Δθ_{d} of the angular orientation difference Δθ at which the light will be refracted at a desired refraction angle γ_{d} formed between a desired pointing direction and the central rotation axis; and
direct the first and second RPA motors to adjust the angular orientations of the first and second prism elements to cause the light to emerge from the RPA in the desired pointing direction when the light enters the RPA along the central rotation axis, or direct the first and second RPA motors to cause the light to emerge from the RPA along the central rotation axis when the light enters the RPA along the desired pointing direction.

2. The RPA of claim 1, wherein γₘᵢₙ=0.

3. The RPA of claim 1, wherein applying the MFP comprises:
A) establishing converging angle variable Δθ_{c} and limiting angle variables Δθ_{L1}, Δθ_{L2}, γ_{L1}, and γ_{L2}, said limiting angle variables having initial values Δθ_{L1}=0 degrees, Δθ_{L2}=180 degrees, γ_{L1}=γₘₐₓ, and γ_{L2}=γₘᵢₙ;
B) setting Δθ_{c}=(Δθ_{L2}−Δθ_{L1})[(γ_{L1}−γ_{d})/(γ_{L1}−γ_{L2})];
C) applying ray tracing to determine a refraction angle γ_{c} between the beam of light and the central rotation axis, and an angular rotation ϕ_{c} of the beam of light about the central rotation axis, that would result if the beam of light entered the RPA along the central rotation axis while the angular orientation θ₁ of the first prism element was equal to 0 and the angular orientation θ₂ of the second prism element was equal to Δθ_{c};
D) if γ_{c} is greater than γ_{d}, setting Δθ_{L1}=Δθ_{c} and γ_{L1}=γ_{c}, or, if γ_{c} is less than γ_{d}, setting Δθ_{L2}=Δθ_{c} and γ_{L2}=γ_{c};
E) repeating steps B) through D) until |γ_{c}−γ_{d}| is less than a specified maximum; and
F) setting Δθ_{d}=Δθ_{c}.

4. The RPA of claim 3, wherein the angular orientations of the first and second prism elements are adjusted according to Δθ_{d}, ϕ_{c} and a desired angle of rotation ϕ_{d} of the desired pointing direction about the central rotation axis.

5. The RPA of claim 4, wherein, according to applicable criteria, adjusting the angular orientations of the first and second prism elements comprises either:
rotating the first prism element to angular orientation θ₁=ϕ_{d}−ϕ_{c}, and rotating the second prism element to angular orientation θ₂=ϕ_{d}−ϕ_{c}+Δθ_{d}; or
rotating the first prism element to angular orientation θ₁=ϕ_{d}+ϕ_{c}, and rotating the second prism element to angular orientation θ₂=ϕ_{d}+ϕ_{c}−Δθ_{d}.

6. The RPA of claim 5, wherein the applicable criteria include at least one of:
minimizing a slew time required for the first RPA motor to rotate the first prism element to angular orientation θ₁ and the second RPA motor to rotate the second prism element to angular orientation θ₂;
minimizing a peak power required for the first RPA motor to rotate the first prism element to angular orientation θ₁ and for the second RPA motor to rotate the second prism element to angular orientation θ₂; and
minimizing a total energy required for the first RPA motor to rotate the first prism element to angular orientation θ₁ and for the second RPA motor to rotate the second prism element to angular orientation θ₂.

7. The RPA of claim 1, wherein the Risley Prism Assembly is achromatic.

8. The RPA of claim 1, wherein γₘₐₓ and γₘᵢₙ are determined according to calibrating measurements applied to the first and second prism elements.

9. The RPA of claim 8, wherein for each of the first and second prism elements the calibrating measurements include a measurement of a tilt angle and direction of a pointing axis about which light refracted by the prism element rotates as the prism element is rotated, and further providing incorporating the measured tilt angles and directions of the pointing axes into the ray tracing.

10. A computer program product embodied on a non-transitory computer readable storage medium, the computer program product comprising instructions configured for processing scanning instructions for an optical assembly by causing a controller to:
accept a desired pointing direction characterized by a desired refraction angle γ_{d} formed between a desired pointing direction and a central rotation axis of a Risley prism assembly (RPA), and a desired angle of rotation ϕ_{d} of the desired pointing direction about the central rotation axis, wherein the RPA comprises a first prism element and a second prism element, each of the first and second prism elements having an angular orientation about the central rotation axis that is variable by causing respective first and second RPA motors to rotate the first and second prism elements about the central rotation axis, and wherein light entering the RPA along the central rotation axis and passing through both of the first and second prism elements is refracted away from the central rotation axis at a maximum refraction angle γₘₐₓ when an angular orientation difference Δθ between the angular orientation θ₁ of the first prism elements and the angular orientation θ₂ of the second prism element is zero, and at a minimum refraction angle γₘᵢₙ when Δθ=180 degrees;
apply an iterative root finding method of false position (MFP) to approximate a value Δθ_{d} of the angular orientation difference Δθ at which the light will be refracted at a desired refraction angle γ_{d} formed between a desired pointing direction and the central rotation axis; and
direct the first and second RPA motors to adjust the angular orientations of the first and second prism elements to cause the light to emerge from the RPA in the desired pointing direction when the light enters the RPA along the central rotation axis, or cause the light to emerge from the RPA along the central rotation axis when the light enters the RPA along the desired pointing direction

11. The computer program product of claim 10, wherein γₘᵢₙ=0.

12. The computer program product of claim 10, wherein applying the MFP comprises:
A) establishing converging angle variable Δθ_{c} and limiting angle variables Δθ_{L1}, Δθ_{L2}, γ_{L1}, and γ_{L2}, said limiting angle variables having initial values Δθ_{L1}=0 degrees, Δθ_{L2}=180 degrees, γ_{L1}=γₘₐₓ, and γ_{L2}=γₘᵢₙ;
B) setting Δθ_{c}=(Δθ_{L2}−Δθ_{L1})[(γ_{L1}−γ_{d})/(γ_{L1}−γ_{L2})];
C) applying ray tracing to determine a refraction angle γ_{c} between the beam of light and the central rotation axis, and an angular rotation ϕ_{c} of the beam of light about the central rotation axis, that would result if the beam of light entered The computer program product along the central rotation axis while the angular orientation θ₁ of the first prism element was equal to 0 and the angular orientation θ₂ of the second prism element was equal to Δθ_{c};
D) if γ_{c} is greater than γ_{d}, setting Δθ_{L1}=Δθ_{c} and γ_{L1}=γ_{c}, or, if γ_{c} is less than γ_{d}, setting Δθ_{L2}=Δθ_{c} and γ_{L2}=γ_{c};
E) repeating steps B) through D) until |γ_{c}−γ_{d}| is less than a specified maximum; and
F) setting Δθ_{d}=Δθ_{c}.

13. The computer program product of claim 12, wherein the instructions are configured to cause the controller to adjust the angular orientations of the first and second prism elements according to Δθ_{d}, ϕ_{c} and a desired angle of rotation ϕ_{d} of the desired pointing direction about the central rotation axis.

14. The computer program product of claim 13, wherein, according to applicable criteria, the instructions are configured to cause the controller to adjust the angular orientations of the first and second prism elements by either:
rotating the first prism element to angular orientation θ₁=ϕ_{d}−ϕ_{c}, and rotating the second prism element to angular orientation θ₂=ϕ_{d}−ϕ_{c}+Δθ_{d}; or
rotating the first prism element to angular orientation θ₁=ϕ_{d}+ϕ_{c}, and rotating the second prism element to angular orientation θ₂=ϕ_{d}+ϕ_{c}−Δθ_{d}.

15. The computer program product of claim 14, wherein the applicable criteria include at least one of:
minimizing a slew time required for the first RPA motor to rotate the first prism element to angular orientation θ₁ and the second RPA motor to rotate the second prism element to angular orientation θ₂;
minimizing a peak power required for the first RPA motor to rotate the first prism element to angular orientation θ₁ and for the second RPA motor to rotate the second prism element to angular orientation θ₂; and
minimizing a total energy required for the first RPA motor to rotate the first prism element to angular orientation θ₁ and for the second RPA motor to rotate the second prism element to angular orientation θ₂.

16. The computer program product of claim 12, wherein for each of the prism elements the instructions are configured to cause the controller to incorporate into the ray tracing a measured value of a tilt angle and direction of a pointing axis for the prism element, the pointing axis being an axis about which light refracted by the prism element rotates as the prism element is rotated.

17. The computer program product of claim 10, wherein the Risley Prism Assembly is achromatic.
